(19) United States
(12) Patent Application Publication
(10) Pub. No.: US 2012/0311551 A1
(43) Pub. Date: Dec. 6, 2012

(54) AUTOMATION OF POST-LINKER FUNCTIONS IN EMBEDDED APPLICATIONS

(75) Inventors: Brandon S. Johnson, Lexington, KY (US); Mark D. Marik, Denver, NC (US)

(73) Assignee: International Business Machines Coporation, Armonk, NY (US)

(21) Appl. No.: 13/153,682

(22) Filed: Jun. 6, 2011

(51) Int. Cl. G06F 9/45

(52) U.S. Cl. 717/153

(57) ABSTRACT

An embedded system post-linker optimization automation method can include connecting to a network file system, coordinating a first handshaking procedure to initiate an embedded application from the network file system, coordinating a second handshaking procedure to initiate a training phase of the embedded application and coordinating a third handshaking procedure to initiate generation of an optimized embedded application from the embedded application during an optimization phase.

### BACKGROUND

The present invention relates to embedded processor compiling/linking, and more specifically, systems and methods for automating post-linker functions in embedded applications.

Post-linker optimization tools in embedded processors rearrange the main line application's routines contained within the executable binary image to reduce the underlying processor's cache misses, thereby improving overall performance of the application. The application's post-linker binary image is rearranged based upon performance feedback obtained by a test program that drives the functions of the embedded application. The feedback technique entails obtaining empirical performance rates for an application that has undergone numerous post-linker optimizations with various optimization strings, then concluding with the use of one of these optimizations that produce the best performance results.

One shortcoming of post-linker optimization with embedded systems often manifests itself in the manual effort required to iterate through the steps of [1] loading the embedded system with a new post-linker optimized executable application, [2] running a test case suite from a host system to obtain performance data, [3] running the post-linker optimization tool with a different set of optimization parameters based upon the feedback from step [2], to create a new executable binary image, and [4] repeating steps 1 through 3 by some maximum iteration count.

Typically, manual intervention to execute the above steps comes into play with post-linker optimization of embedded systems when the embedded system operates under a processor platform (e.g., PowerPC) that differs significantly from the host system (e.g. Intel processor) that houses the embedded system and from which the test cases are executed. In order for the post-linker optimization tool to create post-linker optimized variations of the embedded application, the optimization tool and the embedded application must share a common O/S platform and computer architecture. Thus, for example, if the embedded application runs under Linux on a PowerPC architecture, then the optimization tool which creates the optimized embedded application must also operate under Linux on a PowerPC architecture. If the PowerPC-based embedded system is physically housed in an Intel-based server, and if the Intel-based server executes test cases across a PCIe interface to the embedded application, then three systems will be required to accomplish the post-linker optimization of the embedded application: [1] the PowerPC embedded system, [2] the Intel-based server in which the embedded system is physically attached and from which test cases are executed, and [3] a PowerPC based server that executes the post-linker optimization tool.

Another difficulty with embedded system post-linker optimization may occur when a terminal emulation program, such as minicom, cannot be executed on the same server that hosts the embedded system; one possible reason being due to a lack of a serial port on the host server which is needed for the connection between the terminal emulation program and the embedded system. An increase in the number of physical entities required by the post-linker optimization process magnifies the complexity involved in accomplishing the process, often requiring human intervention to move data numerous times from one computer system to another within the total system to accomplish all the required optimization steps.

### SUMMARY

Exemplary embodiments include an embedded system post-linker optimization automation method, including connecting to a network file system via a computer, coordinating a first handshaking procedure to initiate an embedded application from the network file system, coordinating a second handshaking procedure to initiate a training phase of the embedded application and coordinating a third handshaking procedure to initiate generation of an optimized embedded application from the embedded application during an optimization phase.

Additional exemplary embodiments include a computer program product including a non-transitory computer readable medium storing instructions for causing a computer to implement an embedded system post-linker optimization automation method, the method including connecting to a network file system, coordinating a first handshaking procedure to initiate an embedded application from the network file system, coordinating a second handshaking procedure to initiate a training phase of the embedded application and coordinating a third handshaking procedure to initiate generation of an optimized embedded application from the embedded application during an optimization phase.

Further exemplary embodiments include an embedded computer system, including a session command connection, a network file system connection and a processor configured to start an embedded application in response to a session command received on the session command connection, wherein the network file system connection is configured to coordinate handshaking file semaphores to automate an embedded system post-linker optimization automation procedure.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a system that connects all respective computing systems for concurrent post-linker optimization of a plurality of embedded applications in accordance with exemplary embodiments.

FIG. 2 illustrates a system flow diagram illustrating a training phase and optimization phase that can be automated in accordance with exemplary embodiments.

FIGS. 3A and 3B illustrate an example of a timing chart illustrating a series of operations implemented by the aforementioned scripts in the training and optimization phases.

FIGS. 4-5 illustrate flowcharts for the operations of the PowerPC-based server of FIG. 1.

FIGS. 6-7 illustrate flowcharts for the operations of the embedded system of FIG. 1.

FIGS. 8-9 illustrate flowcharts for the operations of the Intel-based host server of FIG. 1.

### DETAILED DESCRIPTION

In exemplary embodiments, the systems and methods described herein include scripts that coordinate the handshaking procedures necessary between multiple operating systems to execute post-linker optimization processing steps across the multiple computer systems, thereby reducing or eliminating human effort and manual intervention. In exemplary embodiments, by starting a script on each system component, total automation of the post-linker optimization process can be conducted through script handshaking via file semaphores. The file semaphores can be created, checked for existence, and deleted on a NFS (Network File System) mounted directory that is readable and writeable by all systems across an Ethernet channel. Specific platforms, hardware, processors and operating systems are described herein as illustrative examples. It will be appreciated that numerous platforms, hardware, processors and operating systems are contemplated in other exemplary embodiments.

An embedded system whose peripheral port configuration includes at least one USB and one serial port, has the ability to communicate to other computer systems via USB/Ethernet dongle for NFS mounts; and via serial port for connection with a terminal emulation application such as minicom, that is compatible with Unix-like operating systems such as Linux; or hyperterminal, that is compatible with the Windows operating systems. With Ethernet capability, the embedded system can externally mount an NFS drive (physically located in the embedded system's host) to retrieve newly optimized embedded applications. With serial capability, an external display and keyboard can be used to control the functions of the embedded system's O/S.

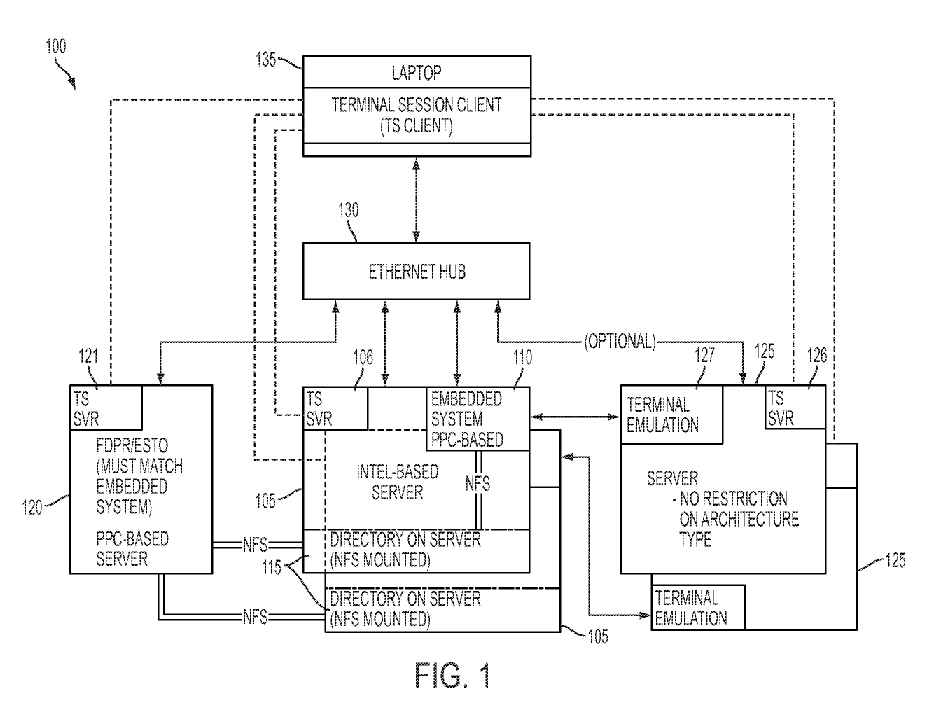

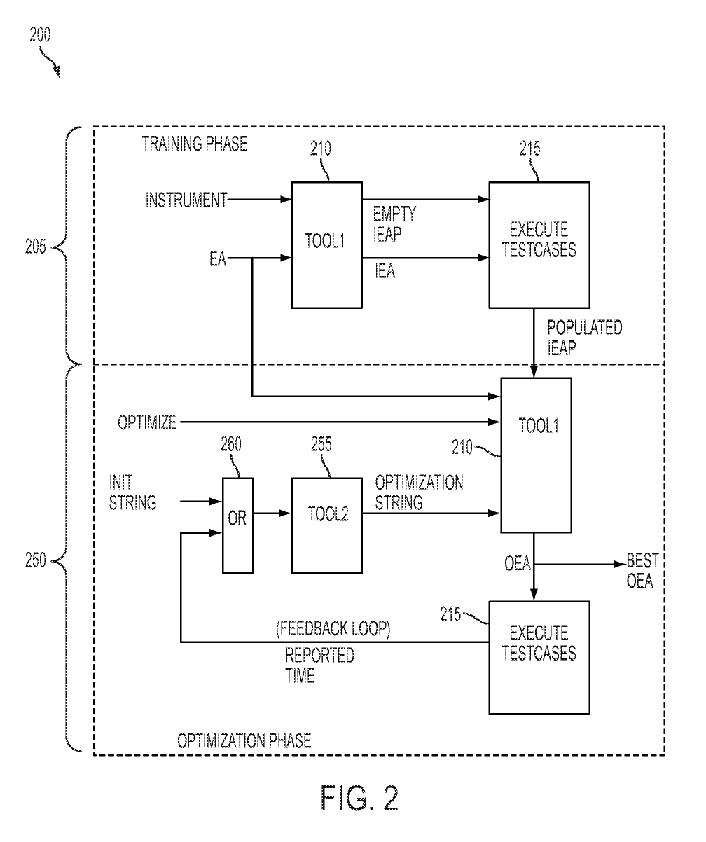

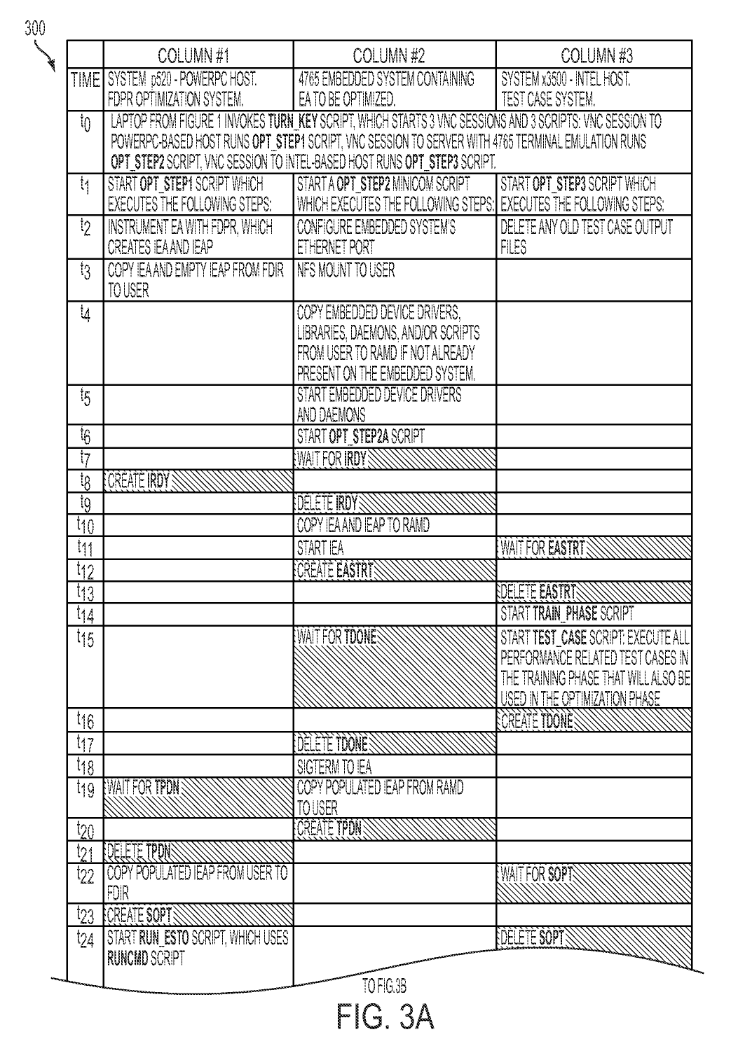

FIG. 1 illustrates a system 100 that connects all respective computing systems for concurrent post-linker optimization of a plurality of embedded applications in accordance with exemplary embodiments. The architectures described herein are just examples. It will be appreciated that there are numerous architectures that can be implemented in other exemplary embodiments. As a convention, solid single lines illustrate physical connections, double solid lines illustrates NFS mounts, and dashed lines illustrate any type of terminal service such as VNC (Virtual Network Computing), remote desktop, or SSH (Secure Shell) terminal sessions, as described further herein. The system 100 includes one or more Intel-based servers 105 each housing an embedded system 110 that is PowerPC-based. Each Intel-based server 105 includes a directory 115 that is NFS mounted by both its hosted embedded system 110 and a separate PowerPC-based 120. The PowerPC-based server 120 executes the post-linker optimization tools. The system 100 can further include emulation servers 125, whose architecture can be any suitable architecture. Each emulation server 125 includes a terminal emulation program 127, (e.g. minicom) and is serially interfaced to one of a plurality of embedded systems 110. The emulation servers 125 can be replaced by a serial connection from the Intel-base servers 105 to the respective hosted embedded system 110 if the Intel-based server 105 has a serial port interface, for example. The system 100 can further include an Ethernet hub 130 that provides a physical connection between all servers 105, 120, 125. The system can further include a terminal session client 135, such as a laptop. For example, when a user responsible for embedded application optimization cannot be physically present next to the servers 105, 120, 125 to coordinate all the steps required for post-linker optimization, the terminal session client 135 can facilitate the initial invocation of the automation scripts remotely.

FIG. 2 illustrates a system flow diagram illustrating a training phase 205 and optimization phase 250 that can be automated in accordance with exemplary embodiments. During the training phase 205, a first optimization tool (i.e., tool1, which can be a Feedback Directed Program Restructuring (FDPR) tool) 210 receives an “instrument” input parameter along with the embedded application executable binary (EA). The first optimization tool 210 reorganizes the EA's most commonly used routines into contiguous space, thereby reducing the number of process cache misses during execution. As such, the first optimization tool generates an empty instrumented embedded application profile (IEAP) and an instrumented embedded application (IEA) executable. The IEAP is a data file that is to be populated by statistical data while the IEA executes host test cases 215 as described further herein. The profile is generated in an empty state. Upon completion of the training phase 205, the profile is considered to be populated. The input EA can be generated by compiling and linking with a standard compiler/linker (e.g., the GNU Compiler Collection (GCC)). In exemplary embodiments, a test case suite is performed against the IEA. As the IEA executes functions, the IEAP is populated with statistical counter values. The populated IEAP is the output of the training phase 205.

In the optimization phase 250, a second optimization tool (i.e., tool 2, which can be an Expert System for Tuning (ESTO) tool) 255 is used in addition to the first optimization tool 210. The second optimization tool 255 automates the process of identifying and tuning a set of optimization options used when generating performance-optimized programs. The second optimization tool 255 can tune the optimization options used by the first optimization tool 210 when creating the post-linker optimized applications within the optimization phase 250. In exemplary embodiments, the populated IEAP, an “optimize” input parameter, the EA, and an initial optimization string (created by the initial invocation of the second optimization tool 255), include the input to the first optimization tool 210 in the optimization phase 250, thus generating a post-linker optimized EA (OEA). The OEA is the EA that is optimized with a particular set of optimization parameters as determined by the second optimization tool 255. In exemplary embodiments, the same test case suite 215 used in the training phase 205 is implemented in the optimization phase 250 to be performed against the OEA. The total time measured to execute the test case suite is computed (i.e., reported time) and is fed back as input the second optimization tool 255 in lieu of the “hit string” parameter, via an “or” function 260. The second optimization tool 255 then determines the next post-linker optimization string that should be used with the next invocation of the first optimization tool 210 within optimization phase 250. This feedback loop executes numerous times until a best (i.e., fastest) performance reported time has been determined. The exemplary systems and methods described herein automate the steps in the training phase 205 and the optimization phase 250 for an embedded system (i.e., the embedded system 110), across multiple operating systems (see FIG. 1) so that no human intervention or manual work is required.

Referring again to FIG. 1, the first optimization tool 210 and the second optimization tool 255 reside on the PowerPC-based server 120, which can be a p520 system. The embedded system 110 can be a PCIe 4765 Cryptographic Coprocessor, which runs on a PowerPC platform under Linux. The embedded system 110 can be physically installed in a PCIe slot within the Intel-based host server 105, which can be an x3500. In exemplary embodiments, the host server 105 sends test cases through a host PCIe device driver to the embedded system 110 that is installed in a PCIe slot. The terminal session client 135 can include three terminal service connections. One service connection 121 is to the PowerPC-based server 120. Another service connection 106 is to the Intel-based server 105. A third service connection 126 is to the emulation servers 125. The terminal session client 135 can run the exemplary automated scripts further described herein (i.e., collectively the TURN_KEY script). The terminal session client 135 can be a VNC service as described herein although it will be appreciated that the terminal service may also be any remote desktop or SSH terminal session.

Several scripts are described herein to correspond to respective automated optimization steps in the training phase 205 and optimization phase 250 as described with respect to FIG. 2. It will be appreciated that the script names are illustrative only for discussion purposes and are not intended to be limiting. A RUN_ESTO script starts the second optimization tool 255 and implements a user customized RUNCMD script. A TURN_KEY script is a top level script that can be started on the terminal session client 135 and is responsible for starting three VNC sessions and scripts: OPT_STEP1, OPT_STEP2, and OPT_STEP3. The OPT_STEP1 script starts operations on the PowerPC-based server 120. The OPT_STEP1 script first creates the instrumented embedded application and profile, and then starts the script supplied by the first and second optimization tools 210, 255, that is, the RUN_ESTO script, in order to generate a series of optimized embedded application candidates until the best performing candidate has been determined. The RUNCMD script is invoked by the RUN_ESTO script, which, in turn, is invoked by the OPT_STEP1 script. The RUNCMD script copies a post-linker optimized embedded application to the embedded system 110, generates a file semaphore indicating the embedded application is ready to be used, then waits for the existence of a file semaphore indicating that the reported time is available, then copies the reported time information that was gathered from the Intel-based Test Case System (105 from FIG. 1) to the second optimization tool 255. The OPT_STEP2 script is invoked by an instantiation of the terminal emulation program 127, which interfaces to the embedded system 110. The OPT_STEP2A script is invoked by the OPT_STEP2 script to delimit the post-linker optimization training phase 205 of an embedded application. As described herein, the training phase 205 gathers the statistical data upon normal (i.e., error-free) running operational characteristics of the application. The OPT_STEP2A script waits for the instrumented embedded application to become ready for use, starts the application, indicates with a file semaphore that the application has started, waits for a file semaphore that indicates test case completion, terminates the application with a signal, then creates a file semaphore to indicate that the statistical data is available. The statistical data is used in combination with run-time performance data (i.e., the reported time) obtained by running the OPT_STEP3 script (described further herein), as input to the post-linker optimization tool set (i.e., the first and second optimization tools 210, 255), to generate the next post-linker optimized executable embedded application candidate.

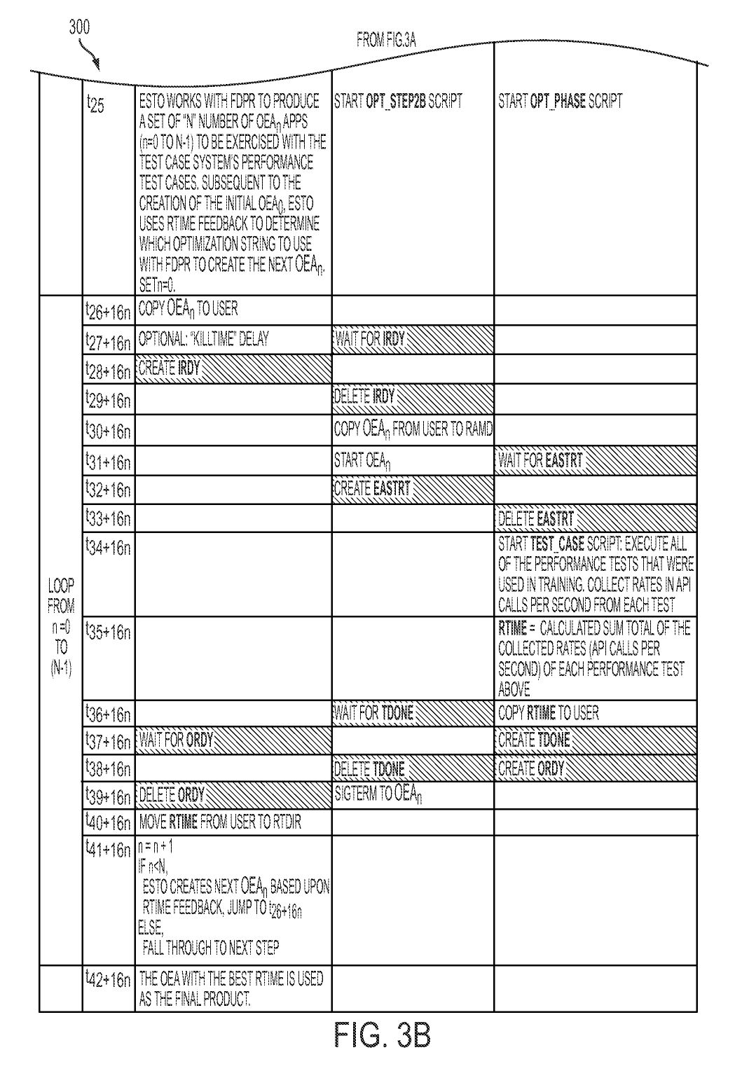

The OPT_STEP2B script is invoked by the OPT_STEP2 script, but after OPT_STEP2A script has completed. The OPT_STEP2B script is used to delimit the lifespan of an embedded application candidate, from start to termination. The OPT_STEP2B script waits for the existence of a file semaphore that indicates a post-linker optimized embedded application has become ready for use, starts the application, indicates with a file semaphore that the application has started, then waits for a file semaphore that indicates performance test case completion, then terminates the application with a signal. The OPT_STEP2B script runs in the loop between t26+16n and t41+16n inclusive (See FIGS. 3A and 3B herein), from n=0 to n=N−1, where N is the maximum number of iterations. Each iteration obtains the performance results of an individual post-linker optimized embedded application candidate.

The OPT_STEP3 script is responsible for executing the host test case suite 215 during the post-linker optimization training phase 205 (i.e., a TRAIN_PHASE script) as well as the optimization phase 250 (i.e., an OPT_PHASE script). The OPT_STEP3 waits for the existence of a file semaphore indicating that the instrumented embedded application is ready, starts the TRAIN_PHASE script (which runs through the test case suite via a TEST_CASE script), generates a file semaphore indicating that the test cases have completed, waits for the existence of a file semaphore indicating that the OPT_STEP1 script has successfully copied the populated profile created by the instrumented post-linker optimized embedded application, then starts the OPT_PHASE script.

The TRAIN_PHASE script is invoked by the OPT_STEP3 script, and is responsible for running test cases on an instrumented embedded application. The OPT_PHASE script is invoked by the OPT_STEP3 script and is responsible for running test cases on a post-linker optimized embedded application candidate. The OPT_PHASE script waits for the existence of a file semaphore indicating that a post-linker optimized embedded application candidate is ready for testing, executes the TEST_CASE script, calculates the sum total (i.e., reported time) of the collected rates (e.g., API calls per second) of each performance test, copies the reported time data to a directory that has been NFS mounted by the server that runs the post-linker optimization tool set (i.e., the first and second optimization tools 210, 255), generates a file semaphore that the embedded system can see that indicates that the test cases are completed so that the OPT_STEP2B script can terminate the embedded application, and generates another file semaphore that the PowerPC server 120 can see that indicates that the reported time is available for use in another iteration of the first and second optimization tools 210, 255 optimization. The TEST_CASE script is responsible for running the test cases that exercise the functions of the embedded application desired to be performance enhanced.

FIGS. 3A and 3B illustrate an example of a timing chart 300 illustrating a series of operations implemented by the aforementioned scripts in the training and optimization phases 205, 250. Column #1, Column #2 and Column #3 each correspond to a separate operating system. In the illustrative example described herein, Column #1 represents the operations performed on the PowerPC-based server 120. Column #2 represents the operations performed on the embedded system 110. Column #3 represents the operations performed on the Intel-based servers 105 running the test cases. The time column represents relative times progressing forward with each subsequent row. It will be appreciated that absolute times between rows are immaterial. In exemplary embodiments, the sequence of operations is paced by file semaphores, which by definition are files created with zero length. File semaphores are generated, tested for existence (i.e., “waited” upon), and deleted as described herein. A file semaphore is generated by one of the three operating systems, described in the illustrative example herein, to indicate that another operating system within the total system 100 is to proceed to its next action. An operating system that waits for a file semaphore deletes that file semaphore once its existence has been generated by another operating system. The Generate, Wait, Delete operations on the file semaphore are highlighted in gray color to facilitate identification. In exemplary embodiments, rows between times t26+16n and t41+16n inclusive, indicate a loop of repeating operations from n=0 to n=N−1, where N is the maximum number of iterations.

At t0: the terminal session client 135 starts the TURN_KEY script.

At t1: the OPT_STEP1 script starts on the PowerPC-based server 120 that hosts the post-linker optimization tool set, that is, the first optimization tool 210 and the second optimization tool 255; the OPT_STEP2 terminal emulation script starts which send commands to the embedded system 110 operating system and the OPT_STEP3 script starts on the Intel-based host server 105 that executes the test case suite.

At t2, the PowerPC-based server 120 instruments the embedded application with the first optimization tool 210, which also creates as output, an empty instrumented application profile. In addition, the embedded system 110 configures its Ethernet port, and the Intel-based host server 105 deletes any old test case output files.

At t3, the PowerPC-based server 120 copies the instrumented embedded application and the empty profile to an NFS mounted directory (named USER) physically located on the Intel-based host server 105. In addition, the embedded system 110 NFS mounts to USER.

At t4, the embedded system 110 copies all the required embedded device drivers, libraries, daemons, and/or scripts from USER to its local memory (e.g., its random access memory (RAM) drive) if not already present on the embedded system 110.

At t5, the embedded system 110 starts its device drivers and daemons.

At t6, the embedded system 110 starts the OPT_STEP2A script.

At t7, the embedded system 110 waits for the existence of the file semaphore, Input Ready (IRDY), indicating that the instrumented embedded application is available on USER.

At t8, the PowerPC-based server 120 creates the file semaphore IRDY indicating that the instrumented embedded application is available on USER.

At t9, the embedded system 110 deletes the file semaphore IRDY indicating that the instrumented embedded application is available on USER.

At t10, the embedded system 110 copies both the instrumented embedded application and the empty profile from USER to its RAM drive.

At t11, the embedded system 110 starts the instrumented embedded application. In addition, the Intel-based host server 105 waits for the existence of a file semaphore, Embedded Application Started (EASTRT) that indicates that the instrumented embedded application has started.

At t12, the embedded system 110 creates the file semaphore EASTRT that indicates that the instrumented embedded application has started.

At t13, the Intel-based host server 105 deletes the file semaphore EASTRT that indicates that the instrumented embedded application has started.

At t14, the Intel-based host server 105 starts the TRAIN_PHASE script.

At t15, the embedded system 110 waits for the existence of a file semaphore, Tests Done (TDONE) that indicates that the test case suite has completed its run on the Intel-based host server 105. In addition, Intel-based host server 105 starts its TEST_CASE script which executes all the test cases that exercise the functions in the embedded system 110 intended to be optimized for faster performance.

At t16, the Intel-based host server 105 creates the file semaphore TDONE that indicates that the test case suite has completed its run on the Intel-based host server 105.

At t17, the embedded system 110 deletes creates the file semaphore TDONE that indicates that the test case suite has completed its run on the Intel-based host server 105.

At t18, the embedded system 110 issues a termination signal to the running embedded application.

At t19, the PowerPC-based server 120 waits for the existence of a file semaphore, Training Phase Done (TPDN) that indicates that the embedded application training phase has completed. In addition, the embedded system 110 copies the populated embedded application profile from its RAM drive to USER.

At t20, the embedded system 110 creates the file semaphore TPDN that indicates that the embedded application training phase has completed.

At t21, the PowerPC-based server 120 deletes creates the file semaphore TPDN that indicates that the embedded application training phase has completed.

At t22, the PowerPC-based server 120 copies the populated embedded application's profile from the NFS mounted directory, USER, to the directory on the PowerPC-based server 120 that executes the post-linker optimization tool set, the first optimization tool 210 and the second optimization tool 255. In addition, the Intel-based host server 105 waits for the existence of a file semaphore, Start Optimization (SOPT) that indicates that the optimization phase should begin.

At t23, the PowerPC-based server 120 creates the file semaphore SOPT that indicates that the optimization phase should begin.

At t24, the PowerPC-based server 120 executes the post-linker optimization RUN_ESTO script that was supplied by the first optimization tool 210 and the second optimization tool 255. This script further invokes the RUNCMD script. In addition, the Intel-based host server 105 deletes the file semaphore SOPT that indicates that the optimization phase should begin.

At t25, on the PowerPC-based server 120, the second optimization tool 255, works with the first optimization tool 210 to produce a set of “N” number of OEAₙ apps (n=0 to N−1) to be exercised with the Intel-based host server 105 performance test case suite. Subsequent to the creation of the initial optimized embedded application, OEA₀, the function of the following iterative loop on the PowerPC-based server 120 between t26+16n and t41+16n inclusive is such that the second optimization tool 255 examines the Reported Time feedback to determine which optimization string to use with the first optimization tool 210 to create the next OEAₙ. Number, n, is set to zero. In addition, the embedded system 110 starts the OPT_STEP2B script and the Intel-based host server 105 starts its script, OPT_PHASE.

At t26+16n, the PowerPC-based server 120 copies the OEAₙ to the NFS mounted directory, USER.

At t27+16n, the PowerPC-based server 120 optionally waits for an amount of time specified by KILLTIME, to give an embedded application time to terminate from a SIGTERM signal on the embedded system 110. In addition, embedded system 110 waits for the existence of a file semaphore IRDY that indicates that an OEAₙ has been copied to the NFS mounted USER directory.

At t28+16n, the PowerPC-based server 120 creates the file semaphore IRDY that indicates that an OEAₙ has been copied to the NFS mounted USER directory.

At t29+16n, the embedded system 110 deletes the file semaphore IRDY that indicates that an OEAₙ has been copied to the NFS mounted USER directory.

At t30+16n, the embedded system 110 copies the OEAₙ from the NFS mounted directory, USER, to its RAM drive.

At t31+16n, the embedded system 110 starts the OEAₙ. In addition, the Intel-based host server 105 waits for the existence of a file semaphore EASTRT that indicates that the optimized embedded application has started.

At t32+16n, the embedded system 110 creates the file semaphore EASTRT that indicates that the optimized embedded application has started.

At t33+16n, the Intel-based host server 105 deletes the file semaphore EASTRT that indicates that the optimized embedded application has started.

At t34+16n, the Intel-based host server 105 starts the TEST_CASE script in order to execute all of the performance tests that were used in the training phase. The Intel-based host server 105 also collects rates in units of “API calls per second” from each individual performance test in the test case suite.

At t35+16n, the Intel-based host server 105 calculates the sum total of the collected rates (API calls per second) of each performance test and assigns this sum to a file named Reported Time.

At t36+16n, the embedded system 110 waits for the existence of a file semaphore TDONE that indicates that the test suite has completed. In addition, the Intel-based host server 105 copies the Reported Time to the USER directory.

At t37+16n, the PowerPC-based server 120 waits for the existence of a file semaphore, Output Ready (ORDY) that indicates that the Reported Time has been copied to USER. In addition, the Intel-based host server 105 creates a file semaphore TDONE that indicates that the test suite has completed.

At t38+16n, the embedded system 110 deletes the file semaphore TDONE that indicates that the test suite has completed. In addition, the Intel-based host server 105 creates a file semaphore ORDY that indicates that the Reported Time has been copied to USER.

At t39+16n, the PowerPC-based server 120 deletes the file semaphore ORDY that indicates that the Reported Time has been copied to USER. In addition, the embedded system 110 issues a termination signal to its running optimized embedded application, OEAₙ.

At t40+16n, the PowerPC-based server 120 copies the Reported Time from NFS mounted directory, USER, to its directory that uses the Reported Time as feedback to decide which optimization string to use to create the next OEAₙ (where n=0 to N−1).

At t41+16n, the PowerPC-based server 120 increments n by 1, and if n<N, where N is the maximum number of optimization iterations, the second optimization tool 255 creates the next OEAₙ based upon the Reported Time feedback. The PowerPC-based server 120 will then jump to t26+16n.

At t42+16n, the PowerPC-based server 120 uses as a final product, the OEAₙ that produced the fastest performance results.

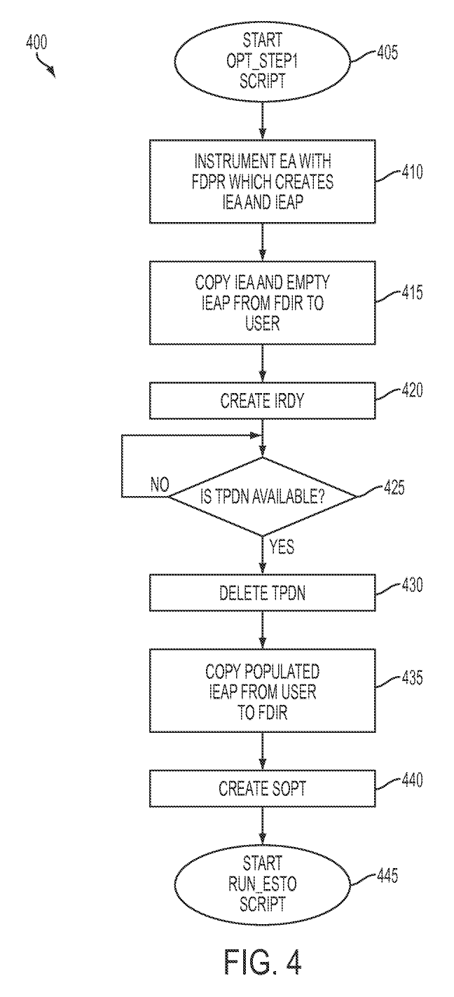

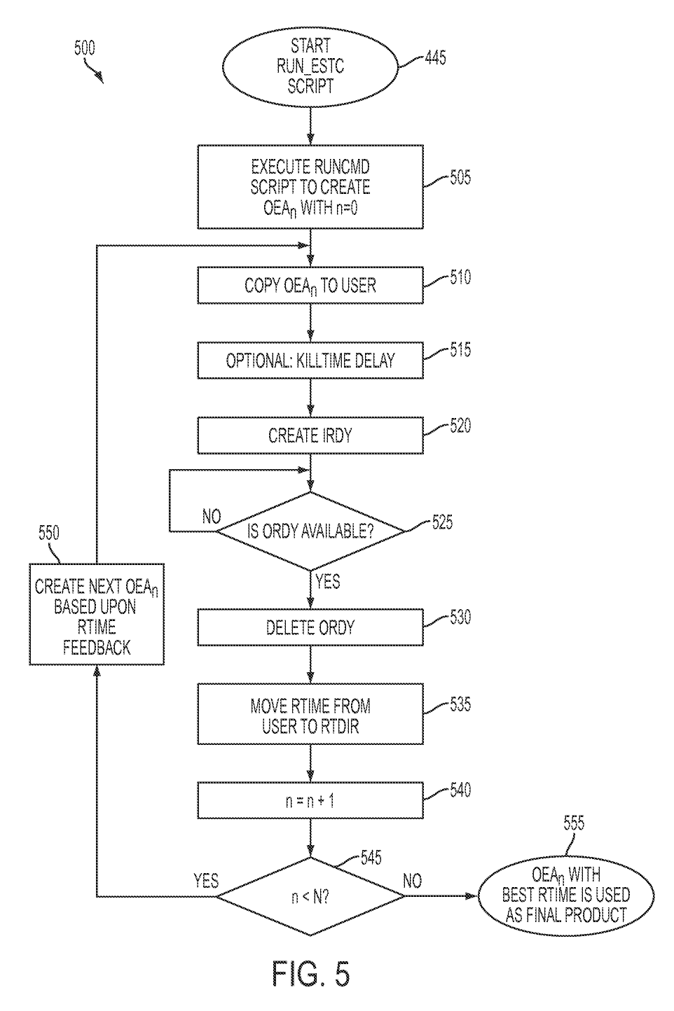

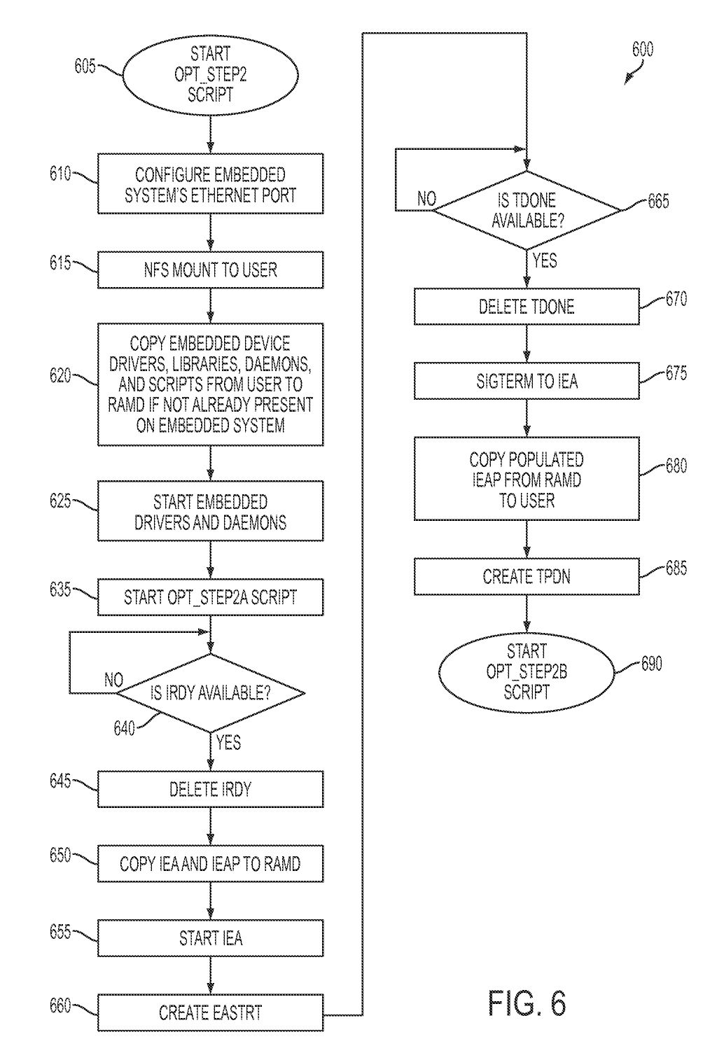

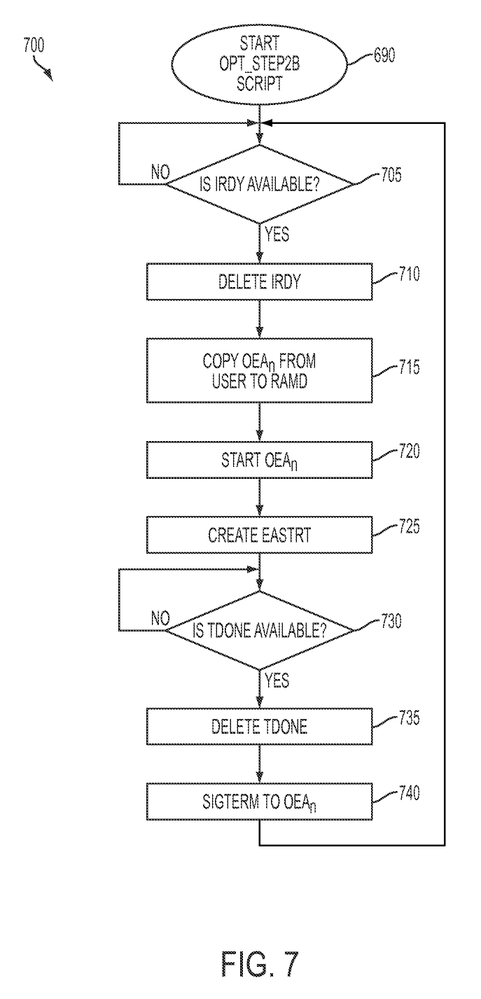

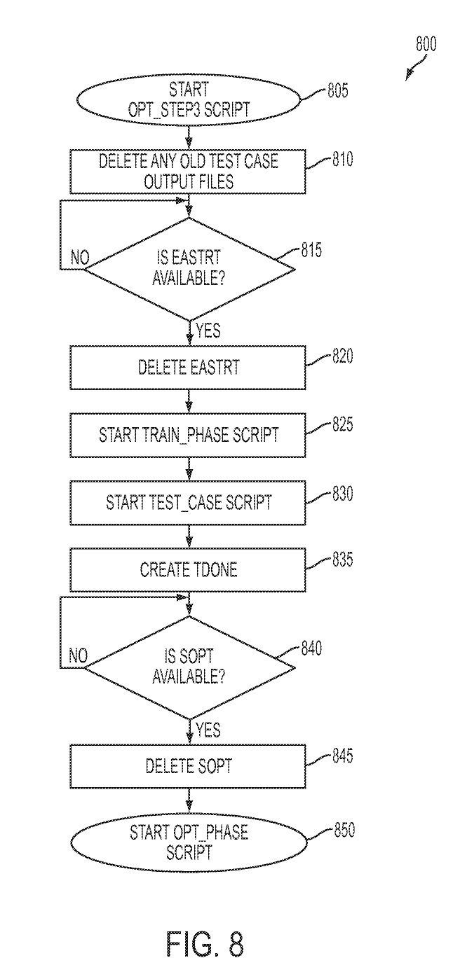

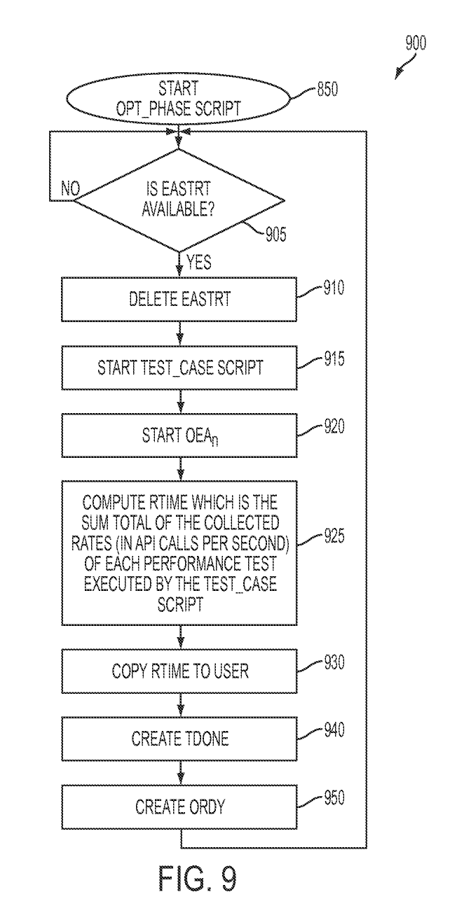

FIGS. 3A and 3B provide the overall timing diagram of the operations implemented by the aforementioned scripts in the training and optimization phases 205, 250 in FIG. 2. FIGS. 4-5 illustrate flowcharts for the operations of the PowerPC-based server 120 of FIG. 1. FIGS. 6-7 illustrate flowcharts for the operations of the embedded system 110 of FIG. 1. FIGS. 8-9 illustrate flowcharts for the operations of the Intel-based host server 105 of FIG. 1.

Referring to FIG. 4, at block 405, the PowerPC-based server 120 starts the OPT_STEP1 script. At block 410, the PowerPC-based server 120 instruments the EA with the first optimization tool 210 to create the IEA and IEAP. At block 415, the PowerPC-based server 120 copies the IEA and empty IEAP from a directory (FDIR) on the PowerPC-based server 120 on which the IEA is created by the first optimization tool 210. At block 420, the PowerPC-based server 120 creates the file semaphore IRDY. At block 425, the PowerPC-based server 120 waits for the file semaphore TPDN. If the file semaphore TPDN is ready at block 425, then at block 430 the PowerPC-based server 120 deletes the file semaphore TPDN. At block 435, the PowerPC-based server 120 copies the populated IEAP from USER to FDIR. At block 440, the PowerPC-based server 120 creates the file semaphore SOPT. At block 445, the PowerPC-based server 120 then starts the RUN_ESTO script.

Referring now to FIG. 5, block 445 from FIG. 4 is illustrated. At block 505 the PowerPC-based server 120 executes the RUNCMD script to create OEAₙ with n=0. At block 510, the PowerPC-based server 120 copies OEAₙ to NFS mounted directory, USER. At block 515, the PowerPC-based server 120 can optionally wait a period KILLTIME, to give an embedded application time to terminate from a SIGTERM signal on the embedded system 110. It can be appreciated that for the first time through the loop shown in FIG. 5, there is no embedded application running and thus no SIGTERM to wait for; however, for illustrative purposes, the KILLTIME delay can still be performed since a delay has no adverse effects upon the operation. At block 520, the PowerPC-based server 120 creates the file semaphore IRDY. At block 525, the PowerPC-based server 120 waits for the file semaphore ORDY to be available. If the file semaphore ORDY is ready at block 525, then at block 530, the PowerPC-based server 120 deletes the file semaphore ORDY. At block 535, the PowerPC-based server 120 moves a reported time file (RTIME) from NFS mounted directory, USER, to a directory that uses RTIME to decide which optimization string to use to create the next OEAₙ (n=0 to N−1). At block 540, the PowerPC-based server 120 n by 1, and if n<N at block 545 (where N is the maximum number of optimization iterations) the second optimization tool 255 creates the next OEAₙ based upon the RTIME feedback at block 550. If n is not less than N at block 545, then at block 555, the OEAₙ with the best time is used as the final product.

Referring now to FIG. 6, at block 605, the embedded system 110 starts the OPT_STEP2 script. At block 610, the embedded system 110 configures its Ethernet port (coupled to the Ethernet hub 130). At block 615, the embedded system 110 creates an NFS mount to directory USER. At block 620, the embedded system 110 copies the embedded device drivers, libraries, daemons and scripts from NFS mounted directory, USER, to a RAM drive (RAMD) defined by the embedded system 110. At block 625, the embedded system 110 started the embedded drivers and daemons. At block 635, the embedded system 110 starts the OPT_STEP2A script. At block 640, the embedded system 110 waits for the file semaphore IRDY to be ready. If the file semaphore IRDY is ready at block 640, then at block 645 the embedded system 110 deletes the file semaphore IRDY. At block 650, the embedded system 110 copies IEA and IEAP to RAMD. At block 655, the embedded system 110 starts IEA. At block 660, the embedded system 110 creates the file semaphore EASTRT. At block 665, the embedded system 110 waits for the availability of the file semaphore TDONE. If the file semaphore TDONE is available at block 665, then at block 670, the embedded system 110 deletes the file semaphore TDONE. At block 675, the embedded system 110 terminates the IEA with a SIGTERM signal. At block 680, the embedded system 110 copies the populated IEAP from RAMD to NFS mounted directory, USER. At block 685, the embedded system 110 creates the file semaphore TPDN. At block 690, the embedded system 110 starts the OPT_STEP2B script.

Referring now to FIG. 7, block 690 from FIG. 6 is illustrated. At block 705, the embedded system 110 waits for the file semaphore IRDY to be available. If the file semaphore IRDY is available at block 705, then at block 710, the embedded system 110 deletes the file semaphore IRDY. At block 715, the embedded system 110 copies OEAₙ from NFS mounted directory USER to RAMD. At block 720, the embedded system 110 starts OEAₙ. At block 725, the embedded system 110 creates the file semaphore EASTRT. At block 730, the embedded system 110 waits for the availability of the file semaphore TDONE. If the file semaphore TDONE is available at block 730, then at block 735, the embedded system 110 deletes the file semaphore TDONE. At block 740, the embedded system 110 terminates OEAₙ with a SIGTERM signal. The operation 700 loops back to 705 to wait for file semaphore IRDY to become available.

Referring now to FIG. 8, at block 805, the Intel-based host server 105 starts the OPT_STEP3 script. At block 810, the Intel-based host server 105 deletes any old test case output files. At block 815, the Intel-based host server 105 waits for the availability of the file semaphore EASTRT. If the file semaphore EASTRT is available at block 815, then at block 820, the Intel-based host server 105 deletes the file semaphore EASTRT. At block 825, the Intel-based host server 105 starts the TRAIN_PHASE script. At block 830, the Intel-based host server 105 starts the TEST_CASE script. At block 835, the Intel-based host server 105 creates the file semaphore TDONE. At block 840, the Intel-based host server 105 waits for the availability of the file semaphore SOPT. If the file semaphore SOPT is available at block 840, then at block 845, the Intel-based host server 105 deletes the file semaphore SOPT. At block 850, the Intel-based host server 105 starts the OPT_PHASE script.

Referring now to FIG. 9, block 850 from FIG. 8 is illustrated. At block 905, the Intel-based host server 105 waits for the availability of the file semaphore EASTRT. If the file semaphore is available at block 905, then at block 910, the Intel-based host server 105 deletes the file semaphore EASTRT. At block 915, the Intel-based host server 105 starts the TEST_CASE script. At block 920, the Intel-based host server 105 starts OEAₙ. At block 925, the Intel-based host server 105 computes RTIME, the sum total of collected rates (in API calls per second) of each performance test executed by the TEST_CASE script. At block 930, the Intel-based host server 105 copies RTIME to USER. At block 940, the Intel-based host server 105 creates the file semaphore TDONE. At block 950, the Intel-based host server 105 creates the file semaphore ORDY. As described herein, the operation 900 loops to block 905.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages or Shell Scripting (e.g. Linux Shell Scripting). The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the embedded system post-linker optimization automation methods are implemented in hardware, the security framework methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include formalizing and automating a post-linker optimization process upon an embedded system application within a system that includes multiple operating systems. The coordination of events between the operating systems is accomplished with file semaphores that can be created, tested for existence, and deleted on a common readable and writeable network file system mounted directory. Both the operating system under which the embedded application executes and the computer architecture on which the embedded system executes are the same as that of the computer system that executes the post-linker optimization tool set. The computer system that hosts the embedded system and which directs test cases upon the embedded system, may execute a different operating system from that of the embedded system, or may include different computer architecture from that of the embedded system, or both. The embedded system includes both a physical serial port on which an external terminal emulation program can attach, and an Ethernet port or a USB port that can function as an Ethernet port in order to access file semaphores on a network file system mounted directory. The network mounted file system directory can physically reside in either the system hosting the embedded system, or the system hosting the post-linker optimization tool set, or some other separate computer system. Each operating system in the total system includes a virtual network computing access point server software program that which allows that computer system to be remotely controlled by one centralized computer having virtual network computing client software; the centralized computer having a turn-key script that starts main scripts in each computer system in the total system. In exemplary embodiments, the embedded system 110 is remotely controlled indirectly by way of the terminal emulation program 127 in the server 125, where the server 125 includes a virtual network computing server access point. The server 125 allows remote control from a terminal session client 135. The server 125 then accesses the embedded system 110 through the terminal emulation program 127. The computer system executing the terminal emulation program to the embedded system may include the same operating system as that of the embedded system, and may include the same computer architecture as that of the embedded system. The steps of each process in each of the operating systems of the total system are paced by the existence or absence of particular file semaphores that are created by another operating system in the total system; and that the operating system which creates a file semaphore is indicating to another operating system in the total system that a particular sub process has been completed and that another sub process on another operating system can commence. Each operating system in the total system operate in concert to achieve the end product of embedded system application that has been optimized to a point of achieving the best performance possible; without any human intervention to execute each of the optimization sub process steps on the various operating systems within the total system. Multiple host systems for multiple embedded systems controlled by a centralized computer, and multiple embedded systems can be post-linker optimized in an automated fashion concurrently.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. An embedded system post-linker optimization automation method, comprising:
connecting, via a computer, to a network file system;
coordinating a first handshaking procedure to initiate an embedded application from the network file system;
coordinating a second handshaking procedure to initiate a training phase of the embedded application; and
coordinating a third handshaking procedure to initiate generation of an optimized embedded application from the embedded application during an optimization phase.

2. The method as claimed in claim 1 wherein the first handshaking procedure includes generating an Embedded Application Started (EASTRT) file semaphore in the network file system, the EASTRT file semaphore indicating that the embedded application has started.

3. The method as claimed in claim 1 further comprising copying a profile data file to the network file system.

4. The method as claimed in claim 3 further comprising populating the profile data file with statistical data from the training phase.

5. The method as claimed in claim 1 wherein the second handshaking procedure includes waiting for a Training Phase Done (TPDN) file semaphore indicating that the training phase of the embedded application is complete.

6. The method as claimed in claim 1 wherein the third handshaking procedure includes receiving an Output Ready (ORDY) file semaphore indicating that an optimized embedded application has been generated.

7. The method as claimed in claim 1 further comprising copying the optimized embedded application to the network file system.

8. A computer program product including a non-transitory computer readable medium storing instructions for causing a computer to implement an embedded system post-linker optimization automation method, the method comprising:
connecting to a network file system;
coordinating a first handshaking procedure to initiate an embedded application from the network file system;
coordinating a second handshaking procedure to initiate a training phase of the embedded application; and
coordinating a third handshaking procedure to initiate generation of an optimized embedded application from the embedded application during an optimization phase.

9. The computer program product as claimed in claim 8 wherein the first handshaking procedure includes generating an Embedded Application Started (EASTRT) file semaphore in the network file system, the EASTRT file semaphore indicating that the embedded application has started.

10. The computer program product as claimed in claim 8 wherein the method further comprises copying a profile data file to the network file system.

11. The computer program product as claimed in claim 10 wherein the method further comprises populating the profile data file with statistical data from the training phase

12. The computer program product as claimed in claim 8 wherein the second handshaking procedure includes waiting for a Training Phase Done (TPDN) file semaphore indicating that the training phase of the embedded application is complete.

13. The computer program product as claimed in claim 8 wherein the third handshaking procedure includes receiving an Output Ready (ORDY) file semaphore indicating that an optimized embedded application has been generated.

14. The computer program product as claimed in claim 8 wherein the method further comprises copying the optimized embedded application to the network file system.

15. An embedded computer system, comprising:
a session command connection;
a network file system connection; and
a processor configured to start an embedded application in response to a session command received on the session command connection,
wherein the network file system connection is configured to coordinate handshaking file semaphores to automate an embedded system post-linker optimization automation procedure.

16. The system as claimed in claim 15 wherein the embedded system post-linker optimization automation procedure includes:
connecting to a network file system;
copying a profile data file to the network file system;
coordinating a first handshaking procedure to initiate the embedded application from the network file system;
coordinating a second handshaking procedure to initiate a training phase of the embedded application;
coordinating a third handshaking procedure to initiate generation of an optimized embedded application from the embedded application during an optimization phase.

17. The system as claimed in claim 16 wherein the first handshaking procedure includes generating an Embedded Application Started (EASTRT) file semaphore in the network file system, the EASTRT file semaphore indicating that the embedded application has started.

18. The system as claimed in claim 16 wherein the second handshaking procedure includes waiting for a Training Phase Done (TPDN) file semaphore indicating that the training phase of the embedded application is complete.

19. The system as claimed in claim 16 wherein the embedded system post-linker optimization automation procedure further comprises populating the profile data file with statistical data from the training phase.

20. The system as claimed in claim 16 wherein the third handshaking procedure includes receiving an Output Ready (ORDY) file semaphore indicating that an optimized embedded application has been generated, wherein the optimized embedded application is copied to the network file system.
